(19) United States
(12) Patent Application Publication
(10) Pub. No.: US 2025/0106266 A1
(43) Pub. Date: Mar. 27, 2025

(54) Methods, Systems and Computer Program Products for Optimizing Identification of Communication Device Based Spamming

(71) Applicant: TRUECALLER INTERNATIONAL LLP, Gurugram (IN)

(72) Inventors: Abhinav Bhatnagar, Bangalore (IN); Dhanesh Padmanabhan, Kolar (IN)

(21) Appl. No.: 18/726,220

(22) PCT Filed: Jan. 2, 2023
(86) PCT No.: PCT/IB2023/050012

§ 371 Date: Jul. 2, 2024

(30) Foreign Application Priority Data
Jan. 3, 2022 (IN) 202211000188

(51) Int. Cl. H04L 65/1076; H04L 51/212

(52) U.S. Cl. CPC H04L 65/1076; H04L 51/212

(57) ABSTRACT

The invention is directed towards prevention (or a reduction in the incidence) of unsolicited voice calls and/or unsolicited messaging content on communication devices. The invention relies on a communication origination categorization server configured for implementing the steps of (i) identifying a number for a communication origination categorization decision, wherein the identified number is associated with a first telephony device that has initiated a communication with a second telephony device, (ii) identifying application user feedback information associated with the identified number, (iii) identifying at least one of calling behaviour information associated with the identified number and messaging behaviour information associated with the identified number, (iv) generating a communication origination categorization decision based on at least one or both of the identified calling behaviour information and the identified messaging behaviour information, and (v) transmitting to the second telephony device, the communication origination categorization decision.

### CROSS-REFERENCE TO RELATED APPLICATIONS

This application is the United States national phase of International Patent Application No. PCT/IB2023/050012 filed Jan. 2, 2023, and claims priority to Indian Patent Application number 202211000188 filed Jan. 3, 2022, the disclosures of which are hereby incorporated by reference in their entireties.

### BACKGROUND OF THE INVENTION

### Field of the Invention

The invention relates to identification and/or prevention of communication device based spamming. In particular, the invention provides methods, systems and computer program products configured to enable prevention (or a reduction in the incidence) of unsolicited voice calls and/or unsolicited messaging content on telephony based communication devices.

### Description of Related Art

The incidence of unsolicited voice calls and/or unsolicited text messages (“spam”) has increased significantly with the global spread of mobile telephony services, and with the corresponding development of sophisticated techniques for telephone number collection, automated call generation and sending of text messages to multiple recipients. The availability of access to cheap voice based and text based telephony services makes spamming a particularly attractive option for certain commercial entities—and more often than not, the content of such “spam” is of dubious relevance to the recipient.

The costs of spamming activity can be high for recipients, including productivity loss, overcrowded message boxes, and the risks of missing relevant calls or message content due to the high incidence of spam. Costs of the spamming activity are also borne by telecommunication service providers-who are constantly challenged to increase available network capacity to cope with the ever increasing incidence of spamming activity.

With the introduction of smartphones, and specialized smartphone based software applications (such as Truecaller™)—users of smartphones are able to use specific features within such software applications, such as Caller ID and Spam identification and/or Spam filtering to block or filter unsolicited voice calls or text based message content.

### SUMMARY OF THE INVENTION

FIGS. 1 and 2 illustrate exemplary telecommunication system environments and the manner in which software applications currently enable identification of spam communications.

FIG. 1 illustrates a conventional telecommunication system environment 100—wherein a caller 102 may initiate a voice based call or send a text message to a recipient 114. Caller 102 operates a caller device 104 (for example, a smartphone/mobile phone 104a or a wired telephone 104b) to establish a voice based call with, or to send a text message to a recipient device 112 (for example, a smartphone/mobile phone 112a or a wired telephone 112b) operated by recipient 114. The voice based call or text message is communicated between caller device 104 and recipient device 112 through telecommunication network 108—wherein caller device 104 accesses telecommunication network 108 through caller switching device/public switched telephone network gateway 106, while recipient device 112 accesses telecommunication network 108 through recipient switching device/public switched telephone network gateway 110.

FIG. 2 illustrates the conventional telecommunication system environment 100 of FIG. 1—wherein the recipient device 112 is a smart phone/mobile communication device 112 that is capable of executing a software application configured for communication origination categorization. By virtue of the software application implemented therewithin, recipient device 112 responds to receipt of an incoming voice call or incoming message based communication by forwarding information concerning the incoming voice call or incoming message based communication, through data network 216 (for example, the internet) to communication origination categorization server platform 218.

Communication origination categorization server platform 218 comprises a communication origination categorization server 218a, a network interface 218b, and a communication origination categorization database 218c.

Communication origination categorization server 218a is configured to (i) receive (through network interface 218b) voice call or text message communication related information transmitted by recipient device 112, (ii) determine based on data records stored within communication origination categorization database 218c, whether the voice call or text message communication contains parameters indicative that said voice call or text message is likely to be spam, and (iii) transmit back to the software application within recipient device 212 (through data network 216) an outcome of the determination, so that recipient 214 or the software application within recipient device 212 can either allow or reject the call or message communication.

Existing communication origination categorization solutions (of the type that would be implemented within communication origination categorization server platform 218) use straightforward heuristics for identifying spam related calls and spam related message communications—and principally rely on users of the software application (on recipient device 112) for identifying calls or message communications from specific telephone numbers as being spam related. Future calls or message communications originating from a telephone number that has been identified as being responsible for spam calls or spam message communications in the past, can accordingly also be identified and blocked.

These heuristics based solutions rely on one or more of:
User feedback identifying certain telephone numbers as being responsible for spam activity, and
Whitelists or blacklists that are collated over time through publicly available data sets and user feedback

Using existing heuristic based solutions, it can take upto 200 to 300 calls or messages originating from a spammer's telephone number, to begin to consistently identify the telephone number as a source of spam communications. Additionally, the ease and regularity with which spammers are able to obtain new telephone numbers or an entire block of telephone numbers for simultaneous use, makes it yet more difficult for existing heuristic solutions to accurately and consistently identify spam activity.

There is accordingly a need for effective and consistent identification of spam activity, to enable recipients to ignore, reject or block communications from spammers.

### SUMMARY

The invention provides methods, systems and computer program products configured to enable prevention (or a reduction in the incidence) of unsolicited voice calls and/or unsolicited messaging content on telephony based communication devices.

The invention provides a communication origination categorization server configured for generating communication origination categorization decisions corresponding to one or more telephony devices. The server comprises (i) a memory, (ii) a network transceiver, and (iii) a processor.

The processor may be configured to implement the steps of (i) identifying a number for a communication origination categorization decision, wherein the identified number is associated with a first telephony device that has initiated a communication with a second telephony device, (ii) identifying application user feedback information associated with the identified number, (iii) identifying at least one of calling behaviour information associated with the identified number and messaging behaviour information associated with the identified number, (iv) generating a communication origination categorization decision based on at least one or both of the identified calling behaviour information and the identified messaging behaviour information, and (v) transmitting to the second telephony device, the communication origination categorization decision.

In an embodiment, the communication origination categorization server may be configured such that generating the communication origination categorization prediction is also based on the identified application user feedback information.

In another embodiment, the communication origination categorization server may be configured such that generating the communication origination categorization prediction comprises (i) generating a communication origination categorization prediction based on at least one or both of the identified calling behaviour information and the identified messaging behaviour information, and (ii) generating a communication origination categorization decision based on the generated communication organization categorization prediction and one or more whitelists or blacklists.

In a further embodiment of the communication origination categorization server, (i) the first telephony device is a communication device having one or both of voice calling based communication capability and text message based communication capability, and (ii) the second telephony device is a communication device having one or both of voice calling based communication capability, text message based communication capability, and data network based communication capability, wherein said second telephony device is configured for data network based communication with the communication origination categorization server.

The communication origination categorization server may in one embodiment be configured such that the application user feedback information is retrieved from a database communicably coupled with the communication origination categorization server, and the application user feedback information comprises information corresponding to one or more of (i) a number of requests that have been received over a defined period for blocking the first telephony device or for blocking a number associated with the first telephony device, wherein said requests have been received from communication devices that implement instances of a software application configured to communicate with the communication origination categorization server, (ii) a number of requests that have been received over a defined period for whitelisting the first telephony device or for whitelisting a number associated with the first telephony device, wherein said requests have been received from communication devices that implement instances of a software application configured to communicate with the communication origination categorization server, (iii) a number of requests that have been received over a defined period for blacklisting the first telephony device or for blacklisting a number associated with the first telephony device, wherein said requests have been received from communication devices that implement instances of a software application configured to communicate with the communication origination categorization server, (iv) a number of requests that have been received over a defined period for categorizing the first telephony device or for categorizing a number associated with the first telephony device as a business category device or number, wherein said requests have been received from communication devices that implement instances of a software application configured to communicate with the communication origination categorization server, (v) a number of requests that have been received over a defined period for categorizing the first telephony device or for categorizing a number associated with the first telephony device as a personal category device or number, wherein said requests have been received from communication devices that implement instances of a software application configured to communicate with the communication origination categorization server, or (vi) a representative value representing a relationship between (a) a number of requests that have been received over a defined period for blocking or categorizing as a spammer, the first telephony device or a number associated with the first telephony device, and (b) a number of requests that are received for whitelisting the first telephony device number associated therewith, wherein said requests have been received from communication devices that implement instances of a software application configured to communicate with the communication origination categorization server.

The communication origination categorization server may in another embodiment be configured such that the calling behaviour information is retrieved from a database communicably coupled with the communication origination categorization server, and the calling behaviour information comprises information corresponding to one or more of (i) call duration information for outgoing calls from the first telephony device, (ii) call duration information for incoming calls to the first telephony device, (iii) a number of incoming calls to the first telephony device, from communication devices that implement instances of a software application configured to communicate with the communication origination categorization server, (iv) a number of outgoing calls from the first telephony device to communication devices that implement instances of a software application configured to communicate with the communication origination categorization server, (v) a number of outgoing calls from the first telephony device to (a) communication devices that implement instances of a software application configured to communicate with the communication origination categorization server, and (b) that do not have a telephone number associated with the first telephony device stored within their respective contact lists, (vi) a representative value representing a relationship between an (a) average call duration of outgoing calls from the first telephony device, to communication devices that implement instances of a software application configured to communicate with the communication origination categorization server, and (b) average call duration between communication devices that implement instances of a software application configured to communicate with the communication origination categorization server and other communication devices that have instances of the software application installed or implemented thereon, or (vii) information representing time at which calls from the first telephony device are made to communication devices that implement instances of a software application configured to communicate with the communication origination categorization server.

In a particular embodiment of the communication origination categorization server the messaging behaviour information is retrieved from a database communicably coupled with the communication origination categorization server, and the messaging behaviour information comprises information corresponding to one or more of (i) whether the identified number associated with the first telephony device is a short code based number, (ii) whether the identified number associated with the first telephony device is a telephone number, (iii) a number of incoming message based communications received at the first telephony device, from communication devices that implement instances of a software application configured to communicate with the communication origination categorization server, (iv) a number of outgoing message based communications sent from the first telephony device, to communication devices that implement instances of a software application configured to communicate with the communication origination categorization server, (v) a number of outgoing message based communications from the first telephony device to communication devices that (a) implement instances of a software application configured to communicate with the communication origination categorization server, and (b) that do not have a telephone number corresponding to the first telephony device stored within their respective contact lists, or (vi) a representative value representing a relationship between (a) an average interaction time between communication devices that implement instances of a software application configured to communicate with the communication origination categorization server and telephony devices that have been identified as spammer devices, and (b) an average interaction time between communication devices that implement instances of a software application configured to communicate with the communication origination categorization server and other communication devices that have instances of the software application installed or implemented thereon.

In a specific embodiment of the communication origination categorization server, the second telephony device is configured for (i) displaying contents of the communication origination categorization decision on a display, (ii) responding to receiving the communication origination categorization decision by (a) parsing the received communication origination categorization decision, and (b) responsive to the communication origination categorization decision comprising information categorizing the first telephony device as a spammer device, (1) blocking an incoming voice communication or message based communication from the first telephony device, (2) blocking future incoming voice communications or message based communications from the first telephony device, or (3) terminating an ongoing communication session between the first telephony device and the second telephony device.

The invention also provides a method for generating communication origination categorization decisions corresponding to one or more telephony devices. The method comprises implementing at a communication origination categorization server, the steps of (i) identifying a number for a communication origination categorization decision, wherein the identified number is associated with a first telephony device that has initiated a communication with a second telephony device, (ii) identifying application user feedback information associated with the identified number, (iii) identifying at least one of calling behaviour information associated with the identified number and messaging behaviour information associated with the identified number, (iv) generating a communication origination categorization decision based on at least one or both of the identified calling behaviour information and the identified messaging behaviour information, and (v) transmitting to the second telephony device, the communication origination categorization decision.

In a method embodiment, generating the communication origination categorization prediction is also based on the identified application user feedback information.

In another method embodiment, generating the communication origination categorization prediction comprises (i) generating a communication origination categorization prediction based on at least one or both of the identified calling behaviour information and the identified messaging behaviour information, and (ii) generating a communication origination categorization decision based on the generated communication organization categorization prediction and one or more whitelists or blacklists.

In a further embodiment of the method (i) the first telephony device is a communication device having one or both of voice calling based communication capability and text message based communication capability, and (ii) the second telephony device is a communication device having one or both of voice calling based communication capability, text message based communication capability, and data network based communication capability, wherein said second telephony device is configured for data network based communication with the communication origination categorization server.

In a particular embodiment of the method, the application user feedback information is retrieved from a database communicably coupled with the communication origination categorization server, and the application user feedback information comprises information corresponding to one or more of (i) a number of requests that have been received over a defined period for blocking the first telephony device or for blocking a number associated with the first telephony device, wherein said requests have been received from communication devices that implement instances of a software application configured to communicate with the communication origination categorization server, (ii) a number of requests that have been received over a defined period for whitelisting the first telephony device or for whitelisting a number associated with the first telephony device, wherein said requests have been received from communication devices that implement instances of a software application configured to communicate with the communication origination categorization server, (iii) a number of requests that have been received over a defined period for blacklisting the first telephony device or for blacklisting a number associated with the first telephony device, wherein said requests have been received from communication devices that implement instances of a software application configured to communicate with the communication origination categorization server, (iv) a number of requests that have been received over a defined period for categorizing the first telephony device or for categorizing a number associated with the first telephony device as a business category device or number, wherein said requests have been received from communication devices that implement instances of a software application configured to communicate with the communication origination categorization server, (v) a number of requests that have been received over a defined period for categorizing the first telephony device or for categorizing a number associated with the first telephony device as a personal category device or number, wherein said requests have been received from communication devices that implement instances of a software application configured to communicate with the communication origination categorization server, or (vi) a representative value representing a relationship between (a) a number of requests that have been received over a defined period for blocking or categorizing as a spammer, the first telephony device or a number associated with the first telephony device, and (b) a number of requests that are received for whitelisting the first telephony device number associated therewith, wherein said requests have been received from communication devices that implement instances of a software application configured to communicate with the communication origination categorization server.

In yet another method embodiment, the calling behaviour information is retrieved from a database communicably coupled with the communication origination categorization server, and the calling behaviour information comprises information corresponding to one or more of (i) call duration information for outgoing calls from the first telephony device, (ii) call duration information for incoming calls to the first telephony device, (iii) a number of incoming calls to the first telephony device, from communication devices that implement instances of a software application configured to communicate with the communication origination categorization server, (iv) a number of outgoing calls from the first telephony device to communication devices that implement instances of a software application configured to communicate with the communication origination categorization server, (v) a number of outgoing calls from the first telephony device to (a) communication devices that implement instances of a software application configured to communicate with the communication origination categorization server, and (b) that do not have a telephone number associated with the first telephony device stored within their respective contact lists, (vi) a representative value representing a relationship between an (a) average call duration of outgoing calls from the first telephony device, to communication devices that implement instances of a software application configured to communicate with the communication origination categorization server, and (b) average call duration between communication devices that implement instances of a software application configured to communicate with the communication origination categorization server and other communication devices that have instances of the software application installed or implemented thereon, or (vii) information representing time at which calls from the first telephony device are made to communication devices that implement instances of a software application configured to communicate with the communication origination categorization server.

In another embodiment of the method, the messaging behaviour information is retrieved from a database communicably coupled with the communication origination categorization server, and the messaging behaviour information comprises information corresponding to one or more of (i) whether the identified number associated with the first telephony device is a short code based number, (ii) whether the identified number associated with the first telephony device is a telephone number, (iii) a number of incoming message based communications received at the first telephony device, from communication devices that implement instances of a software application configured to communicate with the communication origination categorization server, (iv) a number of outgoing message based communications sent from the first telephony device, to communication devices that implement instances of a software application configured to communicate with the communication origination categorization server, (v) a number of outgoing message based communications from the first telephony device to communication devices that (a) implement instances of a software application configured to communicate with the communication origination categorization server and (b) that do not have a telephone number corresponding to the first telephony device stored within their respective contact lists, or (vi) a representative value representing a relationship between (a) an average interaction time between communication devices that implement instances of a software application configured to communicate with the communication origination categorization server and telephony devices that have been identified as spammer devices, and (b) an average interaction time between communication devices that implement instances of a software application configured to communicate with the communication origination categorization server and other communication devices that have instances of the software application installed or implemented thereon.

The method may include an embodiment wherein the second telephony device is configured for (i) displaying contents of the communication origination categorization decision on a display, (ii) responding to receiving the communication origination categorization decision by (a) parsing the received communication origination categorization decision, and (b) responsive to the communication origination categorization decision comprising information categorizing the first telephony device as a spammer device, (1) blocking an incoming voice communication or message based communication from the first telephony device, (2) blocking future incoming voice communications or message based communications from the first telephony device, or (c) terminating an ongoing communication session between the first telephony device and the second telephony device.

The invention also provides a computer program product for generating communication origination categorization decisions corresponding to one or more telephony devices. The computer program product comprises a non-transitory computer readable medium having a computer readable program code embodied therein, wherein the computer readable program code comprises instructions for implementing within a processor based computing system, the steps of (i) identifying a number for a communication origination categorization decision, wherein the identified number is associated with a first telephony device that has initiated a communication with a second telephony device, (ii) identifying application user feedback information associated with the identified number, (iii) identifying at least one of calling behaviour information associated with the identified number and messaging behaviour information associated with the identified number, (iv) generating a communication origination categorization decision based on at least one or both of the identified calling behaviour information and the identified messaging behaviour information, and (v) transmitting to the second telephony device, the communication origination categorization decision.

### BRIEF DESCRIPTION OF THE DRAWINGS

FIGS. 1 and 2 illustrate exemplary telecommunication system environments and the manner in which software applications currently enable identification of spam calls or spam messages.

FIG. 3 is a graph illustrating a discovered correlation between call duration and the likelihood of the call consisting of spam related content.

FIG. 4 is a graph illustrating a discovered correlation between the time of a call and the likelihood of the call consisting of spam related content.

FIG. 5 illustrates a method of generating a communication origination categorization decision in accordance with the teachings of the present invention.

FIG. 6 illustrates a specific embodiment of method steps implemented for the purpose of generating a communication origination categorization decision in accordance with the teachings of the present invention.

FIG. 7 is a communication flow diagram illustrating the communication flow between system entities when implementing a method of generating a communication origination categorization decision in accordance with the teachings of the present invention.

FIG. 8 illustrates an exemplary communication origination categorization server configured in accordance with the teachings of the present invention.

FIG. 9 illustrates an exemplary communication origination categorization server database configured in accordance with the teachings of the present invention.

FIG. 10 illustrates an exemplary system for implementing the present invention.

### DESCRIPTION OF THE INVENTION

The present invention provides methods, systems and computer program products configured to enable prevention (or a reduction in the incidence) of unsolicited voice calls and/or unsolicited messaging content on communication devices-particularly telephony based communication devices (for example, mobile communication devices, mobile phones, smart phones etc.).

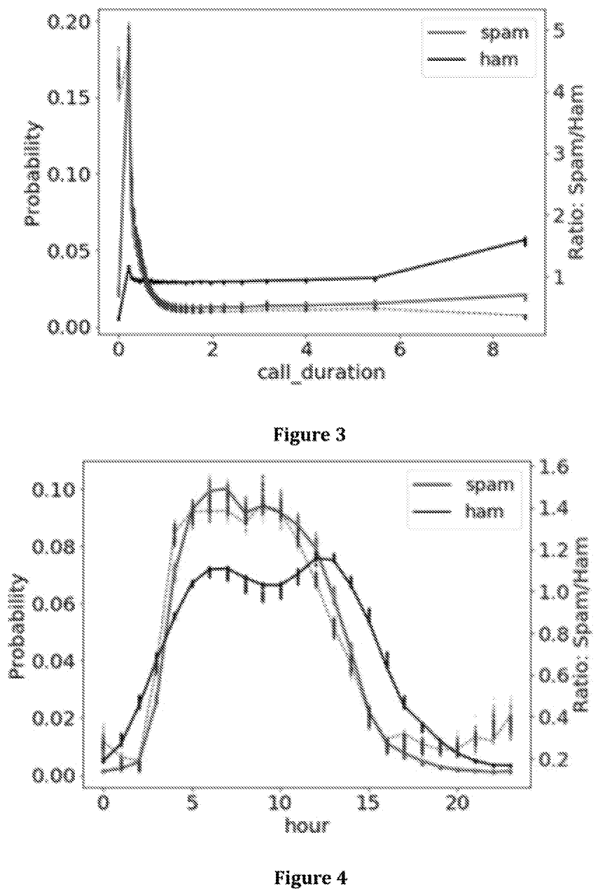

The invention of the present application relies on the observation that a spammer's typical behaviour is quite different from that of a normal caller—and that observation and identification of abnormal behavioural trends consistently seen in the case of spammers can enable identification of future spam activity. Examples of some of the behavioural trends consistently observed in connection with spam activity are illustrated in FIGS. 3 and 4.

FIG. 3 is a graph illustrating a discovered correlation between call duration and the likelihood of the call consisting of spam related content. As will be seen from the graph of FIG. 3, call durations associated with a specific telephone number that are consistently in the region of between 0 and 2 minutes indicates a high probability that the telephone number is associated with spamming activity—whereas telephone numbers associated consistently with longer call durations indicate a significantly lower probability of being associated with spamming activity.

FIG. 4 is a graph illustrating a discovered correlation between call timing and the likelihood of the call consisting of spam related content. As will be seen from the graph of FIG. 4, calls associated with a specific telephone number that are consistently made between 0800 hours and 1400 hours indicate a higher probability that the telephone number is associated with spamming activity, when compared with telephone numbers associated with calls made at other times.

Similar correlations may be seen between the likelihood of a telephone number being associated with spamming activity, and one or more of a cold call fraction (the fraction or percentage of calls made by a number to recipient who does not have the calling telephone number stored as a pre-existing phone book entry or within a recipient's contact list), carrier information, and the caller's voice calling and message based communication behaviour.

Yet another indicator of spamming activity that has been found is the number series to which a spammer's telephone number belongs. For example, it has been observed that spammers often acquire a series of telephone numbers having an identical set of the first five (or six or seven or eight or nine) digits, while the remaining digits differ.

By implementing spam identification methods and systems that recognize and rely on such patterns for spam recognition, the present invention is able to significantly boost sensitivity and specificity of predictions of server platforms that are configured for communication origination categorization and/or spam detection. Yet further, adopting such methodologies has been found to enable systems to detect spam approximately 10 times faster (or based on approximately 10 times fewer spam reportings). In other words, such methodologies have been found to provide real-time spam detection and protection based on data from a significantly smaller base of reporting users.

FIG. 5 illustrates a method of generating a communication origination categorization decision in accordance with the teachings of the present invention.

The method of FIG. 5 may be implemented at a communication origination categorization server 218a (as shown in FIG. 2). In an embodiment, the method of FIG. 5 may be initiated in response to a recipient device 112 receiving an incoming call or incoming text communication (i.e. a message based communication) from a caller device 104. A software application implemented within recipient device 112 may be configured to respond to the incoming call or incoming text communication by transmitting to communication origination categorization server 218a, information concerning the received incoming call or incoming text communication. The information transmitted by recipient device 112 may in an embodiment include at least a telephone number associated with the caller device 104. In an embodiment, the information transmitted by recipient device 112 may comprise part of a request for a communication origination categorization decision associated with the received incoming call or incoming text communication-which request is transmitted from recipient device 112 to communication origination categorization server 218a. Communication origination categorization server 218a may be configured to respond to receipt of the transmitted request or the transmitted information by implementing the method steps of FIG. 5 as discussed below.

Step 502 comprises identifying a number for a communication origination categorization related determination. In an embodiment, the identified number may be a telephone number associated with caller device 104, or may be a part of the telephone number associated with the caller device 104 (i.e. a selected segment of consecutive digits within the telephone number, for example, the first or last or middle 2, 3, 4, 5, 6, 7, 8 or 9 digits within the telephone number), or may be a short code associated with the caller device 104. Communication origination categorization server 218a may extract the number from, or may identify the number based on, information received from recipient device 112.

Step 504 comprises identifying application user feedback information associated with the identified number. Application user feedback information may be identified and retrieved from communication origination categorization database 218c that is communicably coupled with communication origination categorization server 218a. In an embodiment, the application user feedback information comprises information received previously by communication origination categorization server 218a from one or more software applications implemented on one or more recipient devices—wherein said software applications have transmitted information related to the identified number to the communication origination categorization server 218a.

The application user feedback information retrieved from communication origination categorization database 218c may comprise information representing one or more of (i) user feedback categorizing the number, or a telephone number that includes said number, into one or more predefined categories (e.g. spam, business, personal etc.), (ii) user feedback assigning a name or a description to the number or a telephone number that includes said number, (iii) user feedback representing a category of business with which the number, or a telephone number that includes said number, is associated (e.g. medical, infotech, banking, legal etc.), and/or (iv) user feedback representing a request for blacklisting or whitelisting the number, or a telephone number that includes said number.

In more specific embodiments, the application user feedback information retrieved from communication origination categorization database 218c may comprise information representing one or more of:
the number of requests that are received over a defined period (e.g. 30 days or 60 days or since creation of the database 218c) for blocking a particular caller device 104 and/or associated number or telephone number that are received from communication devices that have instances of the software application (that is configured to communicate with communication origination categorization server 218a) installed or implemented thereon.
the number of requests that are received over a defined period (e.g. the last 30 days or 60 days, or since creation of the database 218c) for categorizing or marking a particular caller device 104 and/or associated number or telephone number as a spammer, that are received from communication devices that have instances of the software application (that is configured to communicate with communication origination categorization server 218a) installed or implemented thereon
the number of requests that are received over a defined period (e.g. the last 30 days or 60 days, or since creation of the database 218c) for whitelisting a particular caller device 104 and/or associated number or telephone number, that are received from telephony devices that have instances of the software application (that is configured to communicate with communication origination categorization server 218a) installed or implemented thereon
the number of requests that are received over a defined period (e.g. the last 30 days or 60 days, or since creation of the database 218c) for categorizing or marking a particular caller device 104 and/or associated number or telephone number as a private number, that are received from communication devices that have instances of the software application (that is configured to communicate with communication origination categorization server 218a) installed or implemented thereon
the number of requests that are received over a defined period (e.g. the last 30 days or 60 days or since creation of the database 218c) for categorizing or marking a particular caller device 104 and/or associated number or telephone number as a business number, that are received from communication devices that have instances of the software application (that is configured to communicate with communication origination categorization server 218a) installed or implemented thereon
a ratio or other representative value representing a relationship between (a) the number of requests that are received for blocking or marking as a spammer, a particular caller device 104 and/or associated number or telephone that are received from communication devices that have instances of the software application (that is configured to communicate with communication origination categorization server 218a) installed or implemented thereon and (b) the number of requests that are received for whitelisting the particular caller device 104 and/or associated number or telephone number that are received from communication devices that have instances of the software application (that is configured to communicate with communication origination categorization server 218a) installed or implemented thereon. In a specific embodiment, this representative value Rᵥ may be determined based on the following relationship:

$${R}_{v} = ( \#Blocks / \#Whitelists ) ⋆ A / B$$

wherein:
(1) “#Blocks” is the number of requests that are received for blocking or marking as a spammer, a particular caller device 104 and/or associated number or telephone number that are received from communication devices that have instances of the software application (that is configured to communicate with communication origination categorization server 218a) installed or implemented thereon
(ii) “#Whitelists” is the number of requests that are received for whitelisting, the particular caller device 104 and/or associated number or telephone number that are received from communication devices that have instances of the software application (that is configured to communicate with communication origination categorization server 218a) installed or implemented thereon
(iii) “A” is the historical average value of the number of telephone numbers or caller devices that have been blocked by communication devices that have instances of the software application (that is configured to communicate with communication origination categorization server 218a) installed or implemented thereon, and
(iv) “B” is the historical average value of the number of telephone numbers or caller devices that have been whitelisted by communication devices that have instances of the software application (that is configured to communicate with communication origination categorization server 218a) installed or implemented thereon, and

Step 506 comprises identifying calling behaviour associated with the identified number. Calling behaviour associated with the identified number may be identified based on calling behaviour information retrieved from communication origination categorization database 218c. In an embodiment, the calling behaviour information comprises information representing past calling behaviour of a caller device 104 associated with the number. Such calling behaviour information may have been received and aggregated from one or more software applications implemented on one or more recipient devices 112—wherein said software applications have previously received calls from the caller device 104 associated with the number, and have transmitted to the caller origination categorization server 218a, information representing one or more parameters of calling behaviour associated with said caller device 104 and/or said number or telephone number.

The calling behaviour information retrieved from communication origination categorization database 218c may comprise information representing one or more of:
call duration for outgoing calls from the caller device 104 and/or said number or telephone number
call duration for incoming calls to the caller device 104 and/or said number or telephone number
number of incoming calls to the caller device 104 and/or said number or telephone number, from communication devices that have instances of the software application (that is configured to communicate with communication origination categorization server 218a) installed or implemented thereon
number of outgoing calls from the caller device 104 and/or said number or telephone number, to communication devices that have instances of the software application (that is configured to communicate with communication origination categorization server 218a) installed or implemented thereon
number of outgoing calls from the caller device 104 and/or said number or telephone number, to communication devices that (a) have instances of the software application (that is configured to communicate with communication origination categorization server 218a) installed or implemented thereon and (b) which do not have the number or telephone number stored within their respective contact lists
a ratio or other representative value representing a relationship between an (a) average call duration of outgoing calls from the caller device 104 and/or number or telephone number, to communication devices that have instances of the software application (that is configured to communicate with communication origination categorization server 218a) installed or implemented thereon, and (b) average duration of calls between such communication devices (that have instances of the software application (that is configured to communicate with communication origination categorization server 218a) and other telephony devices that have instances of the software application installed or implemented thereon
information representing time at which calls from the caller device 104 and/or said number or telephone number are made to communication devices that have instances of the software application (that is configured to communicate with communication origination categorization server 218a) installed or implemented thereon

Step 508 comprises identifying messaging behaviour associated with the identified number. Messaging behaviour associated with the identified number may be identified based on messaging behaviour information retrieved from communication origination categorization database 218c. In an embodiment, the messaging behaviour information comprises information representing past message based communication behaviour of a caller device 104 associated with the number. Such message based communication behaviour information may have been received and aggregated from one or more software applications implemented on one or more recipient devices 112—wherein said software applications have previously received messages from the caller device 104 associated with the number, and have transmitted to the communication origination categorization server 218a, information representing one or more parameters of messaging behaviour associated with said caller device 104 and/or said number.

The message based communication behaviour information retrieved from communication origination categorization database 218c may comprise information representing one or more of:
whether the number identifying the caller device 104 from which the message based communication has been received is a short code based number
whether the number identifying the caller device 104 from which the message based communication has been received is a telephone number
a number of incoming message based communications received at the caller device 104 and/or said number or telephone number, from communication devices that have instances of the software application (that is configured to communicate with communication origination categorization server 218a) installed or implemented thereon
a number of outgoing message based communications sent from the caller device 104 and/or said number or telephone number, to communication devices that have instances of the software application (that is configured to communicate with communication origination categorization server 218a) installed or implemented thereon
a number of outgoing message based communications from the caller device 104 and/or said number or telephone number, to communication devices that (a) have instances of the software application (that is configured to communicate with communication origination categorization server 218a) installed or implemented thereon and (b) which do not have the number or telephone number stored within their respective contact lists
a ratio or other representative value representing a relationship between (a) the average interaction time between communication devices that have instances of the software application (that is configured to communicate with communication origination categorization server 218a) installed or implemented thereon and number or telephone numbers that have been marked as “spammer” numbers, and (b) the average interaction time between communication devices that have instances of the software application (that is configured to communicate with communication origination categorization server 218a) installed or implemented thereon and other communication devices that have instances of the software application installed or implemented thereon

Step 510 comprises generating a communication origination categorization decision based on one or more of the identified application user feedback, identified calling behaviour and identified messaging behaviour. In an embodiment, the communication origination categorization decision is generated based on the identified application user feedback, and at least one of the identified calling behaviour and identified messaging behaviour. In an embodiment, the communication origination categorization decision may comprise a decision categorizing the caller device and/or corresponding number or telephone number as a device responsible for spam (i.e. a spam device) or a decision categorizing the caller device and/or corresponding number or telephone number as a device responsible for non-spam communication (i.e. a non-spam or “ham” device).

Subsequent to implementation of step 510, communication origination categorization server 218a may transmit to recipient device 112, the communication origination categorization decision. Recipient device 112 may be configured to display contents of the communication origination categorization decision on a display, to the recipient/user operating said recipient device 112. In another embodiment, recipient device 112 or a software application thereon may be configured to respond to receiving the communication origination categorization decision by (i) parsing the received communication origination categorization decision, and (ii) responsive to the communication origination categorization decision comprising information categorizing caller device 104 as a spammer, (a) blocking the incoming voice communication or message based communication (b) blocking future incoming voice communication or message based communication from the caller device 104 and/or (c) termination the ongoing communication session between caller device 104 and recipient device 112.

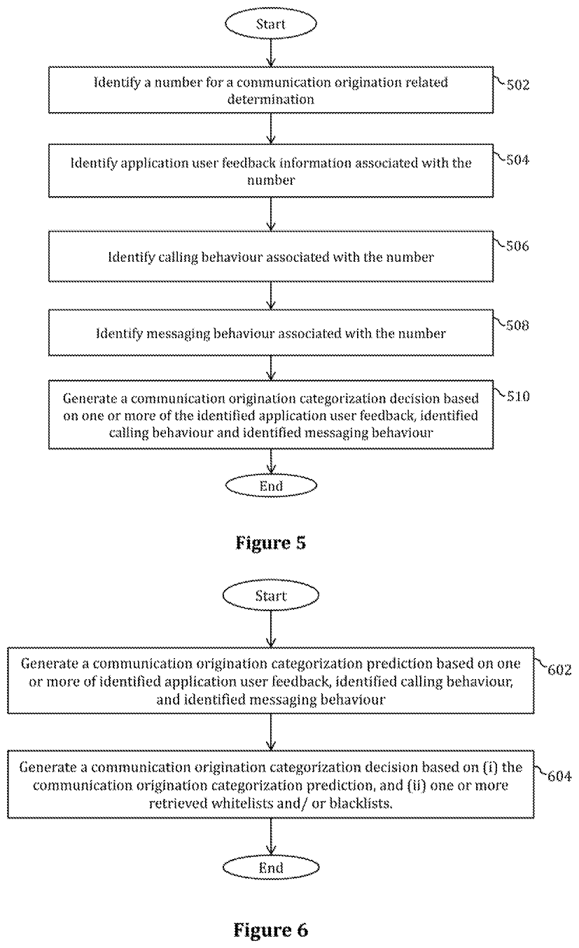

FIG. 6 illustrates a specific embodiment of method steps implemented for the purpose of generating a communication origination categorization decision in accordance with the teachings of the present invention. In a particular embodiment, the method of FIG. 6 is used to implement step 510 of FIG. 5.

Step 602 comprises generating a communication origination categorization prediction based on one or more of identified application user feedback, identified calling behaviour, and identified messaging behaviour (as identified at steps 504, 506 and 508 of FIG. 5 respectively). The communication origination categorization prediction may comprise either (a) a prediction that the caller device 104 is a spammer device, or (b) a prediction that caller device 104 is a non-spammer/ham device.

Thereafter, step 604, generate a communication origination categorization decision based on (i) the communication origination categorization prediction, and (ii) one or more retrieved whitelists and/or blacklists. In various embodiments of step 604
responsive to (i) the communication origination categorization prediction from step 602 comprising a prediction that caller device 104 is a spammer device, and (ii) the number or telephone number associated with the caller device 104 is included within a retrieved blacklist—the generated communication origination categorization decision comprises a decision that caller device 104 is a spammer device.
responsive to (i) the communication origination categorization prediction from step 602 comprising a prediction that caller device 104 is a spammer device, and (ii) the number or telephone number associated with the caller device is not included within any of the retrieved blacklist(s) and whitelist(s)—the generated communication origination categorization decision comprises a decision that caller device 104 is a spammer device
responsive to (i) the communication origination categorization prediction from step 602 comprising a prediction that caller device 104 is a spammer device, and (ii) the number or telephone number associated with the caller device 104 is included within a retrieved whitelist—the generated communication origination categorization decision comprises a decision that caller device 104 is a non-spammer device (i.e. a ham device)
responsive to (i) the communication origination categorization prediction from step 602 comprising a prediction that caller device 104 is a non-spammer device, and (ii) the number or telephone number associated with the caller device 104 is included within a retrieved whitelist—the generated communication origination categorization decision comprises a decision that caller device 104 is a non-spammer device (i.e. a ham device)
responsive to (i) the communication origination categorization prediction from step 602 comprising a prediction that caller device 104 is a non-spammer device, and (ii) the number or telephone number associated with the caller device 104 is not included within any retrieved whitelist(s) or blacklist(s)—the generated communication origination categorization decision comprises a decision that caller device 104 is a non-spammer device (i.e. a ham device)
responsive to (i) the communication origination categorization prediction from step 602 comprising a prediction that caller device 104 is a non-spammer device, and (ii) the number or telephone number associated with the caller device 104 is included within a retrieved blacklist(s)—the generated communication origination categorization decision comprises a decision that caller device 104 is a spammer device (i.e. a ham device)

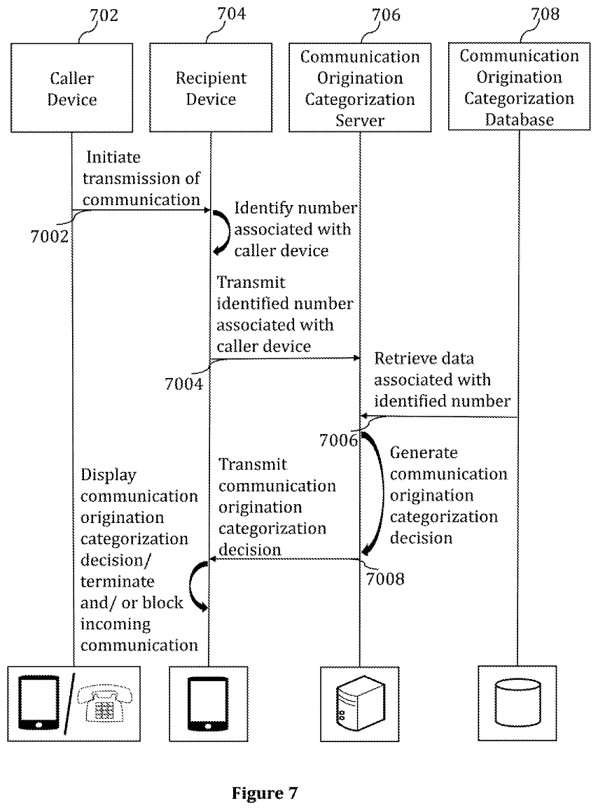

FIG. 7 is a communication flow diagram illustrating the communication flow between system entities when implementing a method of generating a communication origination categorization decision in accordance with the teachings of the present invention.

At step 7002, caller device 702 initiates transmission of a communication (e.g. a voice communication or a text message based communication) to recipient device 704. Recipient device 704 may be configured to respond to receipt of such transmission by communicating with a communication origination categorization server 706 to determine whether caller device 702 is a spammer device.

Recipient device 702 identifies based on information received from caller device 702, or received through one or more intermediary devices positioned between caller device 702 and recipient device 704 (for example from recipient switching device/PSTN gateway 110), a number associated with caller device 702. In an embodiment, the identified number is a telephone number, or a part of a telephone number, or a short code associated with the caller device 702.

Step 7004 comprises transmitting the identified number from recipient device 704 to communication origination categorization server 706. In an embodiment, the information transmitted by recipient device 704 may comprise part of a request for a communication origination categorization decision associated with the received incoming communication-which request is transmitted from recipient device 704 to communication origination categorization server 706.

At step 7006, communication origination categorization server 706 retrieves from a communication origination categorization database 708, data associated with the identified number. The retrieved data may comprise one or more of application user feedback information, calling behaviour information and/or messaging behaviour information associated with the identified number.

Communication origination categorization server 706 thereafter generates a communication origination categorization decision based on the data retrieved at step 7006. The communication origination categorization decision is transmitted at step 7008 to recipient device 704. Responsive to the transmitted communication origination categorization decision at step 7008, recipient device 704 (i) displays the communication origination categorization decision on a display coupled therewith, (ii) blocks the incoming voice communication or message based communication from caller device 702 (iii) blocks future incoming voice communication or message based communication from caller device 702 and/or (iv) terminates the ongoing communication session between caller device 702 and recipient device 704.

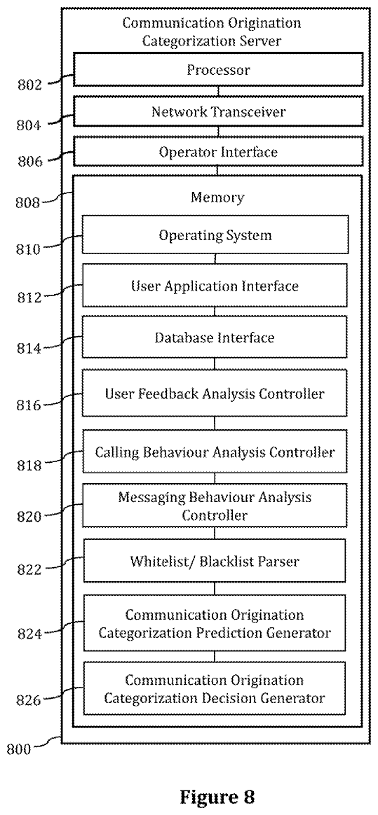

FIG. 8 illustrates an exemplary communication origination categorization server 800 configured in accordance with the teachings of the present invention.

The communication origination categorization server 800 as illustrated and discussed above, may comprise any processor based system or server configured for data processing operations and network based communication. In specific embodiments, communication origination categorization server 800 may comprise one or more servers.

The communication origination categorization server 800 may include (i) a processor 802 configured for data processing operations within communication origination categorization server 800, (ii) a network transceiver 804 configured for enabling network communication to and from communication origination categorization server 800, (iii) an operator interface 806 configured to enable an operator to configure or control communication origination categorization server 800, and (iv) a memory 808, which memory 808 may include transitory memory and/or non-transitory memory.

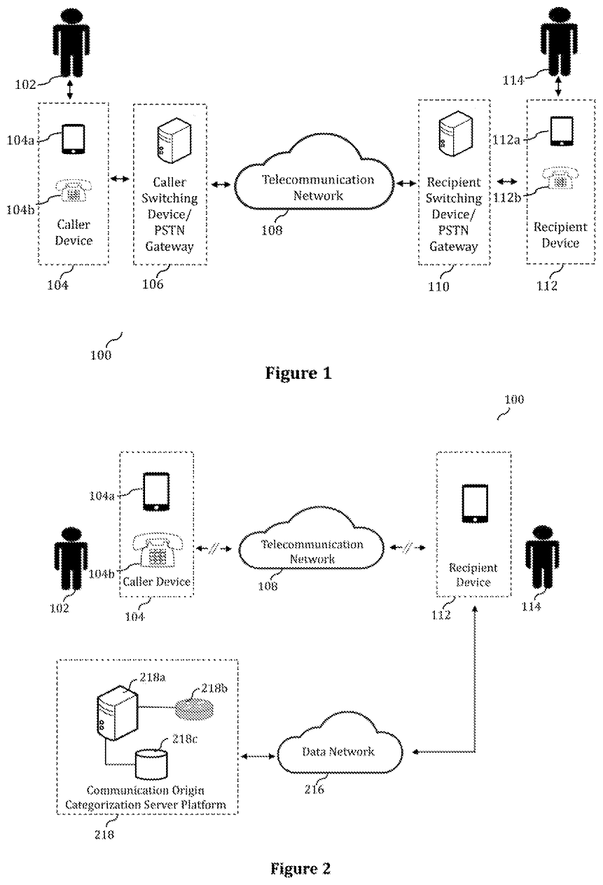

In an exemplary embodiment, memory 808 may have stored therewithin one or more of (i) an operating system 810 configured for managing device hardware and software resources and that provides common services for software programs implemented within communication origination categorization server 800, (ii) a user application interface 812 configured to enable communication origination categorization server 800 to interface with one or more software applications implemented within recipient devices (for example, recipient device 112 of FIGS. 1 and 2), (iii) a database interface 814 configured to enable communication origination categorization server 800 to store data in, and retrieve data from communication origination categorization database (for example, communication origination categorization database 218c of FIG. 2), (iv) a user feedback analysis controller 816 configured to analyze user feedback information retrieved from communication origination categorization database 218c for the purposes of generating a communication origination categorization decision, (v) a calling behaviour analysis controller 818 configured to analyze calling behaviour information retrieved from communication origination categorization database 218c for the purposes of generating a communication origination categorization decision, (vi) a messaging behaviour analysis controller 820 configured to analyze messaging behaviour information retrieved from communication origination categorization database 218c for the purposes of generating a communication origination categorization decision, (vii) a whitelist/blacklist parser 822 configured to parse data from one or more whitelists or blacklists retrieved from communication origination categorization database 218c for the purposes of generating a communication origination categorization decision, (viii) a communication origination categorization prediction generator 824 configured to generate one or more communication origination categorization prediction in accordance with the teachings of the method of FIG. 6, and (ix) a communication origination categorization decision generator 826 configured to generate one or more communication origination categorization decisions in accordance with the teachings of the methods of FIG. 5 and/or FIG. 6.

It will be understood that the communication origination categorization server 800 as illustrated in FIG. 8 may be configured to implement one or more of the method steps and process flows discussed above in connection with FIG. 5, 6 or 7.

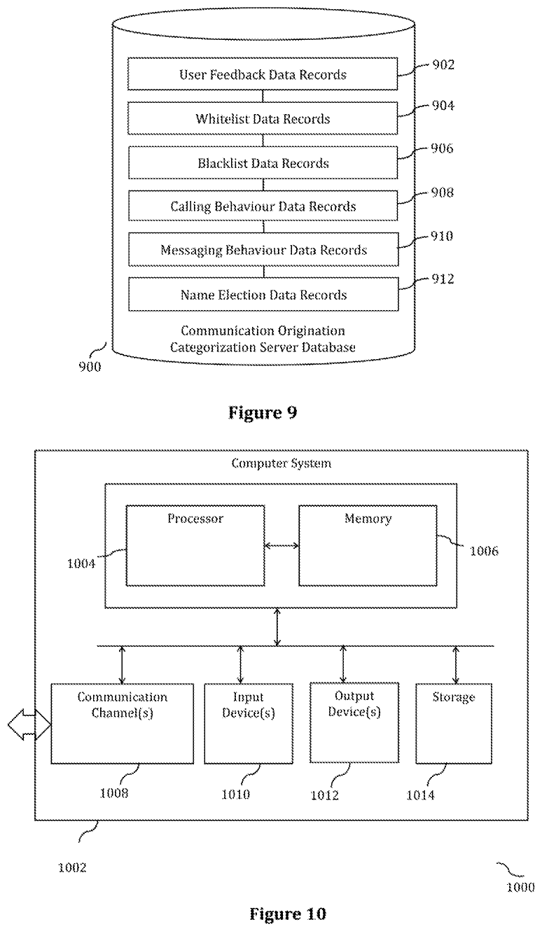

FIG. 9 illustrates an exemplary communication origination categorization server database 900 configured in accordance with the teachings of the present invention. As shown in FIG. 9, communication origination categorization server database 900 may be configured to store and enable retrieval of one or more of user feedback data records 902 (i.e. data records comprising information received by way of user feedback in connection with one or more caller devices), whitelist data records 904 (i.e. data records comprising information identifying one or more telephone numbers that have been whitelisted), blacklist data records 906 (i.e. data records comprising information identifying one or more telephone numbers that have been whitelisted), calling behaviour data records 908 (i.e. data records comprising calling behaviour information of the type described in more detail above), messaging behaviour data records 910 (i.e. data records comprising messaging behaviour information of the type described in more detail above), and/or name election data records 912 (i.e. data records comprising names assigned/suggested/saved/otherwise elected by users in connection with one or more caller devices).

FIG. 10 illustrates an exemplary system for implementing the present invention.

The system of FIG. 10 comprises a computer system 1002 which in turn comprises one or more processors 1004 and at least one memory 1006. Processor 1004 is configured to execute program instructions—and may be a real processor or a virtual processor. It will be understood that computer system 1002 does not suggest any limitation as to scope of use or functionality of described embodiments. The computer system 1002 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1002 in accordance with the present invention may include one or more servers, desktops, laptops, tablets, smart phones, mobile phones, mobile communication devices, tablets, phablets and personal digital assistants. In an embodiment of the present invention, the memory 1006 may store software for implementing various embodiments of the present invention. The computer system 1002 may have additional components. For example, the computer system 1002 may include one or more communication channels 1008, one or more input devices 1010, one or more output devices 1012, and storage 1014. An interconnection mechanism (not shown) such as a bus, controller, or network, interconnects the components of the computer system 1002. In various embodiments of the present invention, operating system software (not shown) provides an operating environment for various softwares executing in the computer system 1002 using a processor 1004, and manages different functionalities of the components of the computer system 1002.

The communication channel(s) 1008 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1010 may include, but is not limited to, a touch screen, a keyboard, mouse, pen, joystick, trackball, a voice device, a scanning device, or any another device that is capable of providing input to the computer system 1002. In an embodiment of the present invention, the input device(s) 1010 may be a sound card or similar device that accepts audio input in analog or digital form. The output device(s) 1012 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1002.

The storage 1014 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1002. In various embodiments of the present invention, the storage 1014 may contain program instructions for implementing any of the described embodiments.

In an embodiment of the present invention, the computer system 1002 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1002. The method described herein is typically implemented as a computer program product, comprising a set of program instructions that is executed by the computer system 1002 or any other similar device. The set of program instructions may be a series of computer readable codes stored on a tangible medium, such as a computer readable storage medium (storage 1014), for example, diskette, CD-ROM, ROM, flash drives or hard disk, or transmittable to the computer system 1002, via a modem or other interface device, over either a tangible medium, including but not limited to optical or analogue communications channel(s) 1008. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be understood that the present invention provides solutions that enable fast and efficient caller origination categorization for real-time categorization of incoming voice or message based communications. It has been found that by implementing the teachings of the present invention, sensitivity and specificity of caller origination categorization has improved by over 30%, while accurate categorization of new numbers can be achieved upto 10 times faster (or based on upto 10 times less data) than was previously possible.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

We claim:

1. A communication origination categorization server configured for generating communication origination categorization decisions corresponding to one or more telephony devices, the server comprising:
a memory;
a network transceiver; and
a processor configured to implement the steps of:
identifying a number for a communication origination categorization decision, wherein the identified number is associated with a first telephony device that has initiated a communication with a second telephony device;
identifying application user feedback information associated with the identified number;
identifying at least one of calling behaviour information associated with the identified number and messaging behaviour information associated with the identified number;
generating a communication origination categorization decision based on at least one or both of the identified calling behaviour information and the identified messaging behaviour information; and
transmitting to the second telephony device, the communication origination categorization decision.

2. The communication origination categorization server as claimed in claim 1, wherein generating the communication origination categorization prediction is also based on the identified application user feedback information.

3. The communication origination categorization server as claimed in claim 1, wherein generating the communication origination categorization prediction comprises:
generating a communication origination categorization prediction based on at least one or both of the identified calling behaviour information and the identified messaging behaviour information; and
generating a communication origination categorization decision based on the generated communication organization categorization prediction and one or more whitelists or blacklists.

4. The communication origination categorization server as claimed in claim 1, wherein:
the first telephony device is a communication device having one or both of voice calling based communication capability and text message based communication capability; and
the second telephony device is a communication device having one or both of voice calling based communication capability, text message based communication capability, and data network based communication capability, wherein said second telephony device is configured for data network based communication with the communication origination categorization server.

5. The communication origination categorization server as claimed in claim 1, wherein the application user feedback information is retrieved from a database communicably coupled with the communication origination categorization server, and the application user feedback information comprises information corresponding to one or more of:
a number of requests that have been received over a defined period for blocking the first telephony device or for blocking a number associated with the first telephony device, wherein said requests have been received from communication devices that implement instances of a software application configured to communicate with the communication origination categorization server;
a number of requests that have been received over a defined period for whitelisting the first telephony device or for whitelisting a number associated with the first telephony device, wherein said requests have been received from communication devices that implement instances of a software application configured to communicate with the communication origination categorization server;
a number of requests that have been received over a defined period for blacklisting the first telephony device or for blacklisting a number associated with the first telephony device, wherein said requests have been received from communication devices that implement instances of a software application configured to communicate with the communication origination categorization server;
a number of requests that have been received over a defined period for categorizing the first telephony device or for categorizing a number associated with the first telephony device as a business category device or number, wherein said requests have been received from communication devices that implement instances of a software application configured to communicate with the communication origination categorization server;
a number of requests that have been received over a defined period for categorizing the first telephony device or for categorizing a number associated with the first telephony device as a personal category device or number, wherein said requests have been received from communication devices that implement instances of a software application configured to communicate with the communication origination categorization server; or
a representative value representing a relationship between (a) a number of requests that have been received over a defined period for blocking or categorizing as a spammer, the first telephony device or a number associated with the first telephony device, and (b) a number of requests that are received for whitelisting the first telephony device number associated therewith, wherein said requests have been received from communication devices that implement instances of a software application configured to communicate with the communication origination categorization server.

6. The communication origination categorization server as claimed in claim 1, wherein the calling behaviour information is retrieved from a database communicably coupled with the communication origination categorization server, and the calling behaviour information comprises information corresponding to one or more of:
call duration information for outgoing calls from the first telephony device;
call duration information for incoming calls to the first telephony device;
a number of incoming calls to the first telephony device, from communication devices that implement instances of a software application configured to communicate with the communication origination categorization server;
a number of outgoing calls from the first telephony device to communication devices that implement instances of a software application configured to communicate with the communication origination categorization server;
a number of outgoing calls from the first telephony device to (a) communication devices that implement instances of a software application configured to communicate with the communication origination categorization server, and (b) that do not have a telephone number associated with the first telephony device stored within their respective contact lists;
a representative value representing a relationship between an (a) average call duration of outgoing calls from the first telephony device, to communication devices that implement instances of a software application configured to communicate with the communication origination categorization server, and (b) average call duration between
communication devices that implement instances of a software application configured to communicate with the communication origination categorization server and other communication devices that have instances of the software application installed or implemented thereon; or
information representing time at which calls from the first telephony device are made to communication devices that implement instances of a software application configured to communicate with the communication origination categorization server.

7. The communication origination categorization server as claimed in claim 1, wherein the messaging behaviour information is retrieved from a database communicably coupled with the communication origination categorization server, and the messaging behaviour information comprises information corresponding to one or more of:
whether the identified number associated with the first telephony device is a short code based number;
whether the identified number associated with the first telephony device is a telephone number;
a number of incoming message based communications received at the first telephony device, from communication devices that implement instances of a software application configured to communicate with the communication origination categorization server;
a number of outgoing message based communications sent from the first telephony device, to communication devices that implement instances of a software application configured to communicate with the communication origination categorization server;
a number of outgoing message based communications from the first telephony device to communication devices that (a) implement instances of a software application configured to communicate with the communication origination categorization server
and (b) that do not have a telephone number corresponding to the first telephony device stored within their respective contact lists; or
a representative value representing a relationship between (a) an average interaction time between communication devices that implement instances of a software application configured to communicate with the communication origination categorization server and telephony devices that have been identified as spammer devices, and (b) an average interaction time between communication devices that implement instances of a software application configured to communicate with the communication origination categorization server and other communication devices that have instances of the software application installed or implemented thereon.

8. The communication origination categorization server as claimed in claim 1, wherein the second telephony device is configured for:
displaying contents of the communication origination categorization decision on a display;
responding to receiving the communication origination categorization decision by (i) parsing the received communication origination categorization decision, and (ii) responsive to the communication origination categorization decision comprising information categorizing the first telephony device as a spammer device, (a) blocking an incoming voice communication or message based communication from the first telephony device, (b) blocking future incoming voice communications or message based communications from the first telephony device, or (c) terminating an ongoing communication session between the first telephony device and the second telephony device.

9. A method for generating communication origination categorization decisions corresponding to one or more telephony devices, comprising implementing at a communication origination categorization server, the steps of:
identifying a number for a communication origination categorization decision, wherein the identified number is associated with a first telephony device that has initiated a communication with a second telephony device;
identifying application user feedback information associated with the identified number;
identifying at least one of calling behaviour information associated with the identified number and messaging behaviour information associated with the identified number;
generating a communication origination categorization decision based on at least one or both of the identified calling behaviour information and the identified messaging behaviour information; and
transmitting to the second telephony device, the communication origination categorization decision.

10. The method as claimed in claim 9, wherein generating the communication origination categorization prediction is also based on the identified application user feedback information.

11. The method as claimed in claim 1, wherein generating the communication origination categorization prediction comprises:
generating a communication origination categorization prediction based on at least one or both of the identified calling behaviour information and the identified messaging behaviour information; and
generating a communication origination categorization decision based on the generated communication organization categorization prediction and one or more whitelists or blacklists.

12. The method as claimed in claim 9, wherein:
the first telephony device is a communication device having one or both of voice calling based communication capability and text message based communication capability; and
the second telephony device is a communication device having one or both of voice calling based communication capability, text message based communication capability, and data network based communication capability, wherein said second telephony device is configured for data network based communication with the communication origination categorization server.

13. The method as claimed in claim 9, wherein the application user feedback information is retrieved from a database communicably coupled with the communication origination categorization server, and the application user feedback information comprises information corresponding to one or more of:
a number of requests that have been received over a defined period for blocking the first telephony device or for blocking a number associated with the first telephony device, wherein said requests have been received from communication devices that implement instances of a software application configured to communicate with the communication origination categorization server;
a number of requests that have been received over a defined period for whitelisting the first telephony device or for whitelisting a number associated with the first telephony device, wherein said requests have been received from communication devices that implement instances of a software application configured to communicate with the communication origination categorization server;
a number of requests that have been received over a defined period for blacklisting the first telephony device or for blacklisting a number associated with the first telephony device, wherein said requests have been received from communication devices that implement instances of a software application configured to communicate with the communication origination categorization server;
a number of requests that have been received over a defined period for categorizing the first telephony device or for categorizing a number associated with the first telephony device as a business category device or number, wherein said requests have been received from communication devices that implement instances of a software application configured to communicate with the communication origination categorization server;
a number of requests that have been received over a defined period for categorizing the first telephony device or for categorizing a number associated with the first telephony device as a personal category device or number, wherein said requests have been received from communication devices that implement instances of a software application configured to communicate with the communication origination categorization server; or
a representative value representing a relationship between (a) a number of requests that have been received over a defined period for blocking or categorizing as a spammer, the first telephony device or a number associated with the first telephony device, and (b) a number of requests that are received for whitelisting the first telephony device number associated therewith, wherein said requests have been received from communication devices that implement instances of a software application configured to communicate with the communication origination categorization server.

14. The method as claimed in claim 9, wherein the calling behaviour information is retrieved from a database communicably coupled with the communication origination categorization server, and the calling behaviour information comprises information corresponding to one or more of:
call duration information for outgoing calls from the first telephony device;
call duration information for incoming calls to the first telephony device;
a number of incoming calls to the first telephony device, from communication devices that implement instances of a software application configured to communicate with the communication origination categorization server;
a number of outgoing calls from the first telephony device to communication devices that implement instances of a software application configured to communicate with the communication origination categorization server;
a number of outgoing calls from the first telephony device to (a) communication devices that implement instances of a software application configured to communicate with the communication origination categorization server, and (b) that do not have a telephone number associated with the first telephony device stored within their respective contact lists;
a representative value representing a relationship between an (a) average call duration of outgoing calls from the first telephony device, to communication devices that implement instances of a software application configured to communicate with the communication origination categorization server, and (b) average call duration between
communication devices that implement instances of a software application configured to communicate with the communication origination categorization server and other communication devices that have instances of the software application installed or implemented thereon; or
information representing time at which calls from the first telephony device are made to communication devices that implement instances of a software application configured to communicate with the communication origination categorization server.

15. The method as claimed in claim 9, wherein the messaging behaviour information is retrieved from a database communicably coupled with the communication origination categorization server, and the messaging behaviour information comprises information corresponding to one or more of:
whether the identified number associated with the first telephony device is a short code based number;
whether the identified number associated with the first telephony device is a telephone number;
a number of incoming message based communications received at the first telephony device, from communication devices that implement instances of a software application configured to communicate with the communication origination categorization server;
a number of outgoing message based communications sent from the first telephony device, to communication devices that implement instances of a software application configured to communicate with the communication origination categorization server;
a number of outgoing message based communications from the first telephony device to communication devices that (a) implement instances of a software application configured to communicate with the communication origination categorization server
and (b) that do not have a telephone number corresponding to the first telephony device stored within their respective contact lists; or
a representative value representing a relationship between (a) an average interaction time between communication devices that implement instances of a software application configured to communicate with the communication origination categorization server and telephony devices that have been identified as spammer devices, and (b) an average interaction time between communication devices that implement instances of a software application configured to communicate with the communication origination categorization server and other communication devices that have instances of the software application installed or implemented thereon.

16. The method as claimed in claim 1, wherein the second telephony device is configured for:
displaying contents of the communication origination categorization decision on a display;
responding to receiving the communication origination categorization decision by (i) parsing the received communication origination categorization decision, and (ii) responsive to the communication origination categorization decision comprising information categorizing the first telephony device as a spammer device, (a) blocking an incoming voice communication or message based communication from the first telephony device, (b) blocking future incoming voice communications or message based communications from the first telephony device, or (c) terminating an ongoing communication session between the first telephony device and the second telephony device.

17. A computer program product for generating communication origination categorization decisions corresponding to one or more telephony devices, the computer program product comprising a non-transitory computer readable medium having a computer readable program code embodied therein, wherein the computer readable program code comprises instructions for implementing within a processor based computing system, the steps of:
identifying a number for a communication origination categorization decision, wherein the identified number is associated with a first telephony device that has initiated a communication with a second telephony device;
identifying application user feedback information associated with the identified number;
identifying at least one of calling behaviour information associated with the identified number and messaging behaviour information associated with the identified number;
generating a communication origination categorization decision based on at least one or both of the identified calling behaviour information and the identified messaging behaviour information; and
transmitting to the second telephony device, the communication origination categorization decision.
